(19) United States
(12) Patent Application Publication
(10) Pub. No.: US 2026/0102928 A1
(43) Pub. Date: Apr. 16, 2026

(54) VEHICLE COMPONENT CARRIER ASSEMBLY

(71) Applicant: GM Global Technology Operations LLC, Detroit, MI (US)

(72) Inventors: Dooil Hwang, Rochester Hills, MI (US); Terebara Hughes, Warren, MI (US); Thiagarajan Chidambareswaran, Sterling Heights, MI (US)

(21) Appl. No.: 18/914,712

(22) Filed: Oct. 14, 2024

(51) Int. Cl. B25J 15/00; B25J 9/16; B25J 13/08; B25J 15/06

(52) U.S. Cl. CPC B25J 15/0028; B25J 9/1679; B25J 13/088; B25J 15/0616

(57) ABSTRACT

A carrier assembly for carrying a vehicle component defines a first axis, a second axis perpendicular to the first axis, and a third axis perpendicular to the first axis and the second axis and includes a carrier frame configured to be coupled to a robot arm assembly, a linear actuator assembly mounted on the carrier frame and including a rod and a linear actuator that moves the rod linearly along the first axis, and a clamp assembly fixed to the rod and configured to be moved linearly along the first axis. The clamp assembly includes a first jaw and a second jaw configured to clamp an edge portion of the vehicle component.

### INTRODUCTION

The subject disclosure relates to vehicles, and in particular to a carrier assembly for a vehicle component.

During vehicle manufacturing, a vehicle component may be carried by a carrier assembly coupled to a robot arm for transporting the vehicle component and/or performing tasks on the vehicle component. Improvements in carrier assemblies may be desirable.

### SUMMARY

In one exemplary embodiment, a carrier assembly for carrying a vehicle component defines a first axis, a second axis perpendicular to the first axis, and a third axis perpendicular to the first axis and the second axis, and comprises a carrier frame configured to be coupled to a robot arm assembly, a linear actuator assembly mounted on the carrier frame and comprising a rod and a linear actuator that moves the rod linearly along the first axis, and a clamp assembly fixed to the rod and configured to be moved linearly along the first axis. The clamp assembly comprises a first jaw and a second jaw configured to clamp an edge portion of the vehicle component.

In addition to one or more of the features described herein, the clamp assembly comprises a clamp arm on which the second jaw is disposed.

In addition to one or more of the features described herein, the clamp arm is configured to rotate about a hinge from an unclamped configuration to a clamped configuration.

In addition to one or more of the features described herein, the carrier assembly further comprises a controller configured to control the linear actuator and a sensor configured to send data indicating a position of the vehicle component to the controller.

In addition to one or more of the features described herein, the controller is configured to control the linear actuator to move the vehicle component to a desired position based on the data from the sensor.

In addition to one or more of the features described herein, the carrier assembly further comprises a grabber assembly configured to grab a surface of the vehicle component.

In addition to one or more of the features described herein, the grabber assembly comprises a suction cup fluidly coupled to a fluid suction mechanism that generates a vacuum force.

In addition to one or more of the features described herein, the fluid suction mechanism is a pump or a blower.

In addition to one or more of the features described herein, the grabber assembly further comprises a grabber housing mounted on the carrier frame and a shaft that passes through the grabber housing so as to be linearly movable with respect to the grabber housing along the third axis, the suction cup being disposed on the shaft.

In addition to one or more of the features described herein, the shaft has a hole extending therethrough along the third axis, the hole fluidly coupling the suction cup and the fluid suction mechanism.

In addition to one or more of the features described herein, the grabber housing comprises a locking structure configured to lock the shaft with respect to the grabber housing.

In addition to one or more of the features described herein, an elastic structure is disposed between the grabber housing and the suction cup, the elastic structure configured to bias the suction cup towards the surface of the vehicle component along the third axis.

In addition to one or more of the features described herein, the carrier frame comprises a beam extending along the first axis, and the grabber housing is directly mounted on a grabber bracket extending from the beam along the second axis.

In addition to one or more of the features described herein, the carrier frame comprises a beam extending along the first axis, and the linear actuator assembly is mounted on a support bracket extending from the beam along the second axis.

In addition to one or more of the features described herein, the clamp assembly comprises a vertical attachment structure, a horizontal attachment structure, and a main body attached to the vertical attachment structure and having the hinge mounted thereon, the first jaw being mounted on one of the vertical attachment structure and the horizontal attachment structure and the rod being attached to the other of the vertical attachment structure and the horizontal attachment structure.

In another exemplary embodiment, a method of operating a carrier assembly defining a first axis, a second axis perpendicular to the first axis, and a third axis perpendicular to the first axis and the third axis comprises moving the carrier assembly to a position above a vehicle component along the third axis, moving clamp assemblies of the carrier assembly along the first axis towards edge portions of the vehicle component until the edge portions are positioned between a first jaw and a second jaw of each of the clamp assemblies, moving the second jaw to clamp the edge portions of the vehicle component between the first jaw and second jaw of each of the clamp assemblies, and performing a task on the vehicle component.

In addition to one or more of the features described herein, moving the carrier assembly to the first position comprises abutting suctions cups of grabber assemblies of the carrier assembly against a surface of the vehicle component and allowing the suction cups and shafts on which the suction cups are mounted to be pushed upward by the surface of the vehicle component along the third axis with respect to grabber housings of the grabber assemblies.

In addition to one or more of the features described herein, the method further comprising locking the shafts of the grabber assemblies so as to be immovable with respect to the grabber housings, and providing vacuum forces to the suction cups such that the suction cups grab the surface of the vehicle component.

In addition to one or more of the features described herein, the method further comprises determining a position of the vehicle component based on data from a sensor, determining differences between actual positions of the clamp assemblies and ideal positions of the clamp assemblies determined based on the position of the vehicle component, and moving the clamp assemblies holding the vehicle component along the third axis to the ideal positions.

In yet another exemplary embodiment, a carrier assembly for carrying a vehicle component defines a first axis, a second axis perpendicular to the first axis, and a third axis perpendicular to the first axis and the second axis, and comprises a carrier frame configured to be coupled to a robot arm assembly, the carrier frame comprising a beam extending along the first axis, a first support bracket and a second support bracket extending from the beam along the third axis, and a first grabber bracket and a second grabber bracket extending from the beam along the second axis, a first linear actuator assembly mounted on the carrier frame via the first support bracket, the first linear actuator assembly comprising first rod and a first linear actuator that moves the first rod linearly along the first axis, a second linear actuator assembly mounted on the carrier frame via the second support bracket, the second linear actuator assembly comprising second rod and a second linear actuator that moves the second rod linearly along the first axis, a first clamp assembly fixed to the first rod and configured to be moved linearly along the first axis, the first clamp assembly comprising a first upper jaw and a first lower jaw configured to clamp a first edge portion of the vehicle component, and a first clamp arm on which the first lower jaw is disposed, a second clamp assembly fixed to the second rod and configured to be moved linearly along the first axis, the second clamp assembly comprising a second upper jaw and a second lower jaw configured to clamp a second edge portion of the vehicle component disposed opposite the first edge portion along the first axis, a fluid suction mechanism that is a pump or a blower configured to generate a vacuum force, a first grabber assembly configured to grab a surface of the vehicle component, the first grabber assembly comprising a first grabber housing mounted on the carrier frame via the first grabber bracket, a first shaft passing through the first grabber housing so as to be linearly movable with respect to the first grabber housing along the third axis, a first suction cup attached to the first shaft and fluidly coupled to the fluid suction mechanism via a first hole formed through the first shaft, a first locking structure within the first grabber housing configured to lock the first shaft with respect to the first grabber housing, and a first elastic structure disposed between the first grabber housing and the first suction cup and configured to bias the first suction cup towards the surface of the vehicle component along the third axis, a second grabber assembly configured to grab a surface of the vehicle component, the second grabber assembly comprising a second grabber housing mounted on the carrier frame via the second grabber bracket, a second shaft passing through the second grabber housing so as to be linearly movable with respect to the second grabber housing along the third axis, a second suction cup attached to the second shaft and fluidly coupled to the fluid suction mechanism via a second hole formed through the second shaft, a second locking structure within the second grabber housing configured to lock the second shaft with respect to the second grabber housing, and a second elastic structure disposed between the second grabber housing and the second suction cup and configured to bias the second suction cup towards the surface of the vehicle component along the third axis, and a controller configured to control the first linear actuator and the second linear actuator and a sensor configured to send data indicating a position of the vehicle component to the controller. The controller is configured to control the first linear actuator and the second linear actuator to move the vehicle component to a desired position based on the data from the sensor.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of a vehicle having vehicle components according to one or more embodiments;

FIG. 2 is a perspective view of a vehicle component carrier assembly coupled to a robot arm assembly and carrying a vehicle component according to one or more embodiments;

FIG. 3 is a perspective view of a vehicle component carrier assembly according to one or more embodiments;

FIG. 4. is a front view of the vehicle component carrier assembly of FIG. 3;

FIG. 5 is a perspective view of the vehicle component carrier assembly of FIG. 3 carrying a vehicle component;

FIG. 6 is a perspective view of a clamp assembly of the vehicle component carrier assembly of FIG. 3 carrying a vehicle component;

FIG. 7A is a front view of the clamp assembly in an extended position according to one or more embodiments;

FIG. 7B is a front view of the clamp assembly in a retracted position according to one or more embodiments;

FIG. 8 is a schematic diagram showing a grabber assembly according to one or more embodiments; and

FIG. 9 is a flow diagram showing a method of operating a vehicle component carrier assembly according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

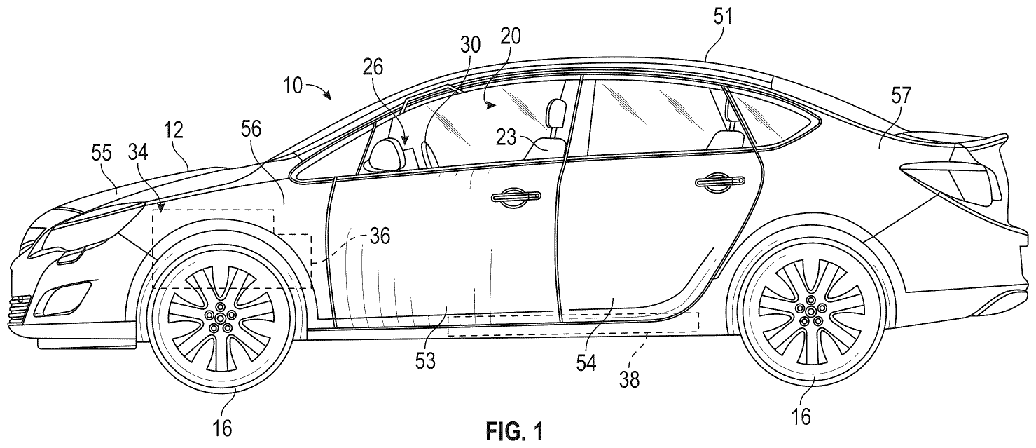

FIG. 1 shows a vehicle 10 according to a non-limiting example. The vehicle 10 includes a vehicle body 12 supported on a plurality of wheels 16. The vehicle body 12 defines, in part, a passenger compartment 20 including a driver seat 23, dashboard 26, and a steering wheel 30. One or more of the wheels 16 may be steerable via the steering wheel 30. The vehicle body 12 further defines, in part, a prime mover compartment that houses a prime mover 34. The prime mover 34 may be, for example, an engine, a motor, or both an engine and a motor in a hybrid configuration. A rechargeable energy storage system (RESS) may be arranged in the vehicle body 12 and may provide power to components within the vehicle 10 (e.g., the prime mover 34). As a non-limiting example, the rechargeable energy storage system may include a battery assembly 38. A gear assembly and/or transmission 36 may be coupled to the prime mover 34 to drive one or more of the wheels 16.

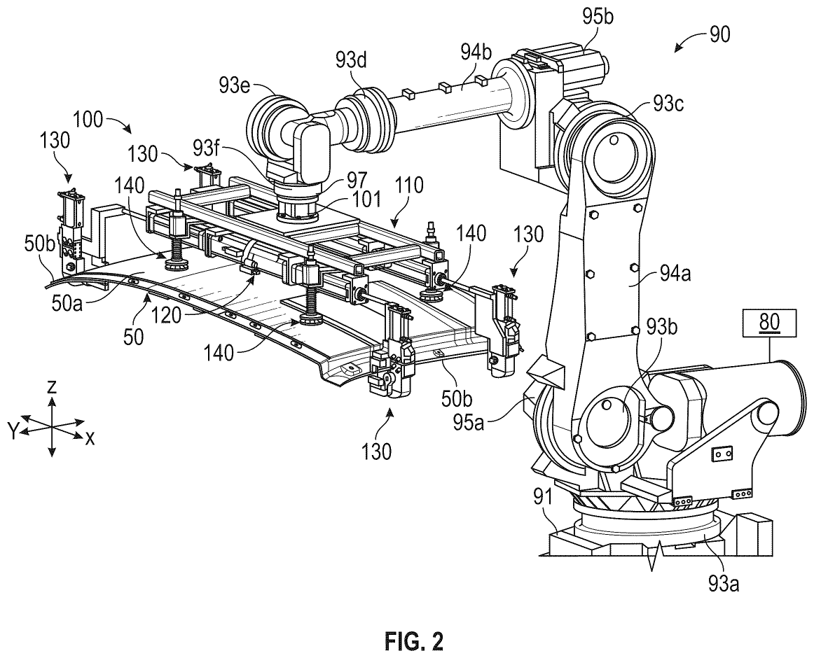

The vehicle body 12 may further include a roof with a roof outer panel 51, one or more front doors with a front door outer panel 53, one or more rear doors with a rear door outer panel 54, a hood with a hood outer panel 55, a fender panel 56, and a quarter panel 57. The roof outer panel 51, the front door outer panel 53, the rear door outer panel 54, the hood outer panel 55, the fender panel 56, and the quarter panel 57 are examples of a vehicle component 50 (see FIG. 2) according to one or more embodiments. However, the vehicle component 50 is not limited thereto.

While specific structures and locations are shown for the roof outer panel 51, the front door outer panel 53, the rear door outer panel 54, the hood outer panel 55, the fender panel 56, and the quarter panel 57 in FIG. 1, these locations are merely exemplary and not limiting, and the structures and locations thereof may vary.

FIG. 2 shows a carrier assembly 100 coupled to a robot arm assembly 90 and carrying a vehicle component 50 according to one or more embodiments. The robot arm assembly 90 includes a base 91, a plurality of rotation mechanisms 93a, 93b, 93c, 93d, 93e, 93f, a plurality of arms 94a, 94b, and a plurality of motors 95a, 95b that may drive one or more of the rotation mechanisms 93a, 93b, 93c, 93d, 93e, 93f, and may terminate at a free end 97.

A carrier assembly 100, which may be an end effector according to one or more embodiments, may be disposed on a free end 97 of the robot arm assembly 90. Specifically, a carrier base 101 of the carrier assembly 100 may be attached to the free end 97 of the robot arm assembly 90 such that the robot arm assembly 90 may move the carrier assembly 100 along multiple degrees of freedom provided by the rotation mechanisms 93a, 93b, 93c, 93d, 93e, 93f.

The carrier assembly 100 defines a first axis X, a second axis Y perpendicular to the first axis X, and a third axis Z perpendicular to the first axis X and the second axis Y. The carrier assembly 100 may include a carrier frame 110 attached to a bottom surface of the carrier base 101, a plurality of linear actuator assemblies 120 coupled to the carrier frame 110, a plurality of clamp assemblies 130 coupled to the linear actuator assemblies 120, and a plurality of grabber assemblies 140 coupled to the carrier frame 110. The clamp assemblies 130 are configured to be moved along the first axis X by the linear actuator assemblies 120 into positions and to clamp and/or hold edge portions 50b of the vehicle component 50. The grabber assemblies 140 are configured to grab a surface 50a of the vehicle component 50.

While four linear actuator assemblies 120, four clamp assemblies 130, and four grabber assemblies 140 are shown, the present disclosure is not limited thereto.

The robot arm assembly 90 and/or the carrier assembly 100 may include a controller 80 configured to control the robot arm assembly 90, the linear actuator assemblies 120, the clamp assemblies 130, and/or the grabber assemblies 140. The controller 80 may be a single controller or multiple controllers. The controller 80 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 80 may be or include a robot controller.

The carrier assembly 100 may be coupled to a sixth axis of the robot arm assembly 90, and a position of the linear actuator assembly 120 and/or the clamp assembly 130 may be controlled by the controller 80. The grabber assembly 140 may have passive position control, a height of the grabber assembly 140 being determined by carrier assembly 100 as the carrier assembly 100 approaches the vehicle component 50.

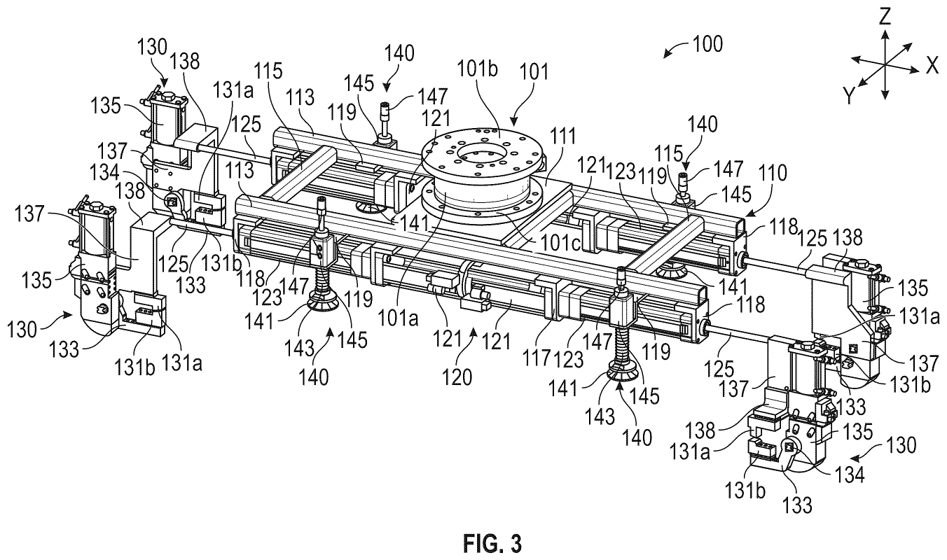

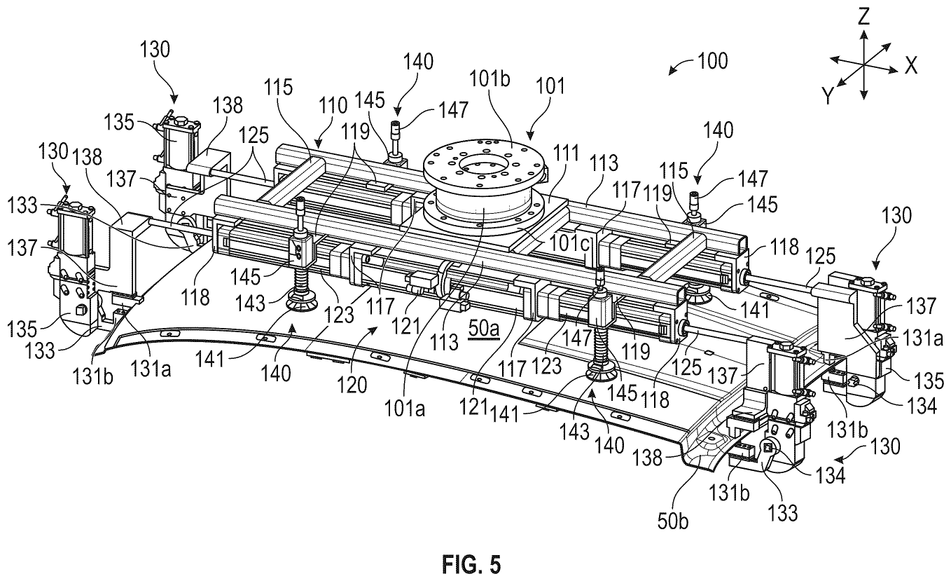

Referring now in FIGS. 3-5, the carrier base 101 may include a cylindrical structure 101a having an upper attachment plate 101b thereabove and a lower attachment plate 101c therebelow. The upper attachment plate 101b may be configured to attach to the free end 97 of the robot arm assembly 90 (see FIG. 2).

The carrier frame 110 may include an attachment base 111 that is attached to the lower attachment plate 101c, and a pair of first beams 113 extending along the first axis X and attached to sides of the attachment base 111 along the second axis Y. A pair of second beams 115 extend between the first beams 113. The carrier frame 110 may further include a plurality of first support brackets 117 and a plurality of second support brackets 118 that extend downward from the first beams 113 along the third axis Z, and a plurality of grabber brackets 119 that extend along the second axis Y.

Each of the linear actuator assemblies 120 may include a linear actuator 121, a housing 123, and a rod 125. The linear actuator 121 may include, for example, a motor and gears (not shown). The linear actuator 121 is operable to move the rod 125 linearly along the X-axis in and out of the housing 123. The linear actuator 121 and/or the housing 123 may be mounted on the carrier frame 110 via the first support bracket 117 and the second support bracket 118. As a non-limiting example, the first support bracket 117 may support an end of the linear actuator 121 along the second axis X and the second support bracket 118 may support an end of the housing 123 along the second axis X.

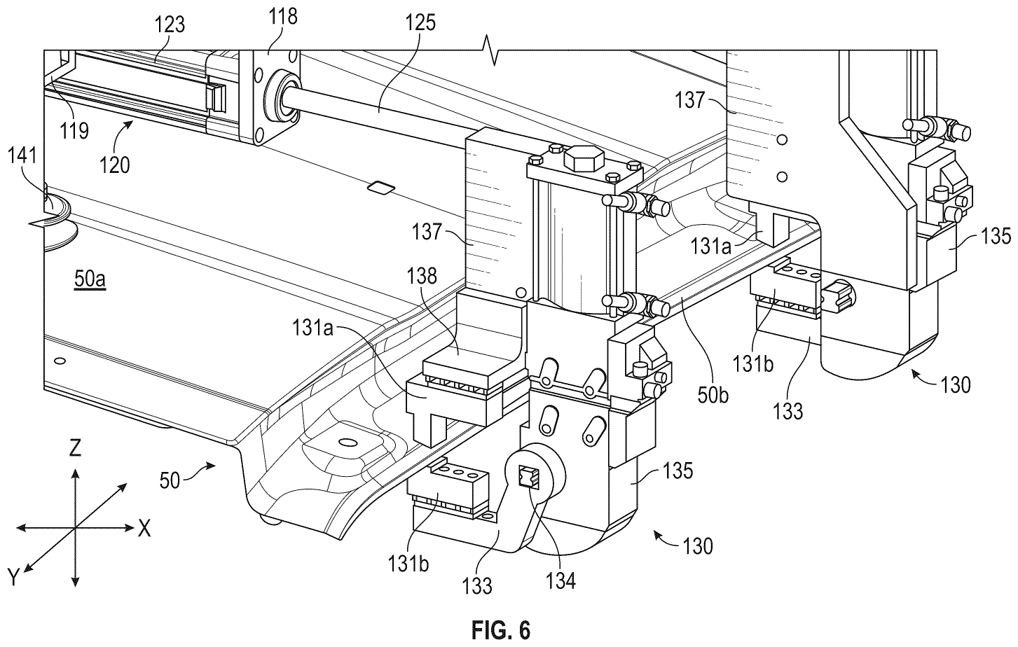

Referring now to FIGS. 3-6, the clamp assemblies 130 may be attached to the rods 125 of the linear actuator assemblies 120. Each of the clamp assemblies 130 may include an upper jaw 131a and a lower jaw 131b. Each of the clamp assemblies 130 may include a main body 135, a vertical attachment structure 137 extending along the third axis Z and attached to the main body 135, and a horizonal attachment structure 138 extending along the second axis Y. As shown in FIG. 3, one of the vertical attachment structure 137 and the horizontal attachment structure 138 may be attached to the rod 125, and the other may be attached to the upper jaw 131a. By varying the size and/or position of the horizontal attachment structure 138, positions of the edge portions 50b of the vehicle component 50 clamped by the upper jaw 131a and the lower jaw 131b along the second axis Y may be adjusted to account for one end of the vehicle component 50 being wider than the other, thus providing better balance. According to one or more embodiments, the upper jaw 131a and/or the lower jaw 131b may be oval-shaped and/or have swivel-tips to accommodate varying angles of the edge portions 50b of different vehicle components 50.

The upper jaw 131a may be fixed with respect to the main body 135, the vertical attachment structure 137, and/or the horizontal attachment structure 138. A clamp arm 133 may be rotationally attached to the main body 135 via a hinge 134, and the lower jaw 131b may be mounted on the clamp arm 133. Thus, the lower jaw 131b may be rotatable with respect to the main body 135 via the clamp arm 133 about the hinge 134. According to one or more embodiments, the main body 135 may include a pneumatic power mechanism such that the hinge 134 is rotated via pneumatic power to rotate the clamp arm 133. According to one or more embodiments, the main body 135 may include a rotational actuator therein (not shown) that rotates the hinge 134 to provide rotational movement for the clamp arm 133. Additionally or alternatively, the clamp arm 133 may be manually rotatable about the hinge 134.

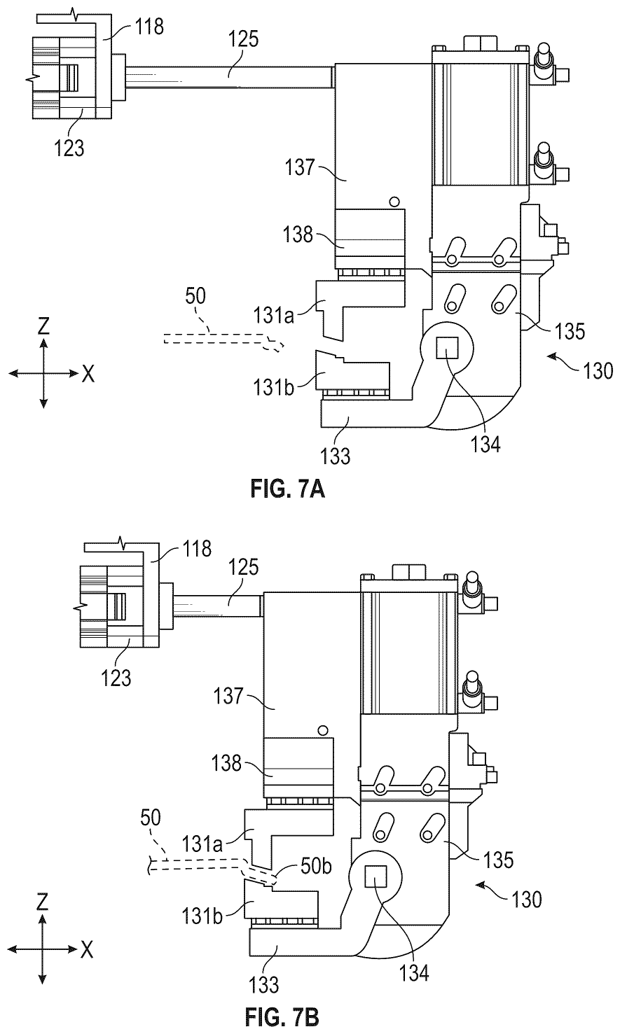

As the linear actuator 121 moves the rod 125 along the X-axis, the clamp assembly 130 disposed on the rod 125 moves linearly along the X-axis. As shown in FIGS. 7A and 7B, as the rod 125 is moved in and out of the housing 123, the clamp assembly 130 moves between an extended position shown in FIG. 7A and a retracted position shown in FIG. 7B.

The clamp assemblies 130 in the extended position with the lower jaws 131b in a lowered position may be positioned on either side of the vehicle component 50, then linearly actuated towards the retracted position until each of the edge portions 50b of the vehicle component 50 are positioned between the upper jaw 131a and the lower jaw 131b of the clamp assemblies 130, FIG. 7B. The linear actuation may then be stopped, and each of the clamp arms 133 may be rotated about the hinge 134 until the lower jaw 131b comes into contact with the edge portions 50b of the vehicle component 50 with sufficient force to bear the weight of the vehicle component 50.

Thereby, the clamp assemblies 130 are able to clamp onto a vehicle component 50 having various sizes, including but not limited to the roof outer panel 51, the front door outer panel 53, the rear door outer panel 54, the hood outer panel 55, the fender panel 56, and the quarter panel 57.

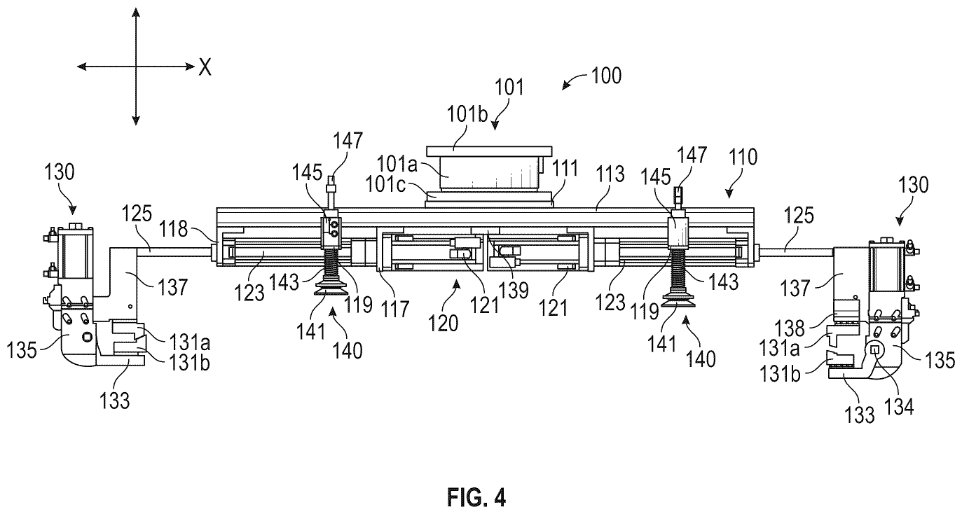

As shown in FIG. 4, the carrier assembly 100 may further include a sensor 139. The sensor 139 may be, for example, an aerial vision sensor or a camera. The sensor 139 may be positioned on a bottom surface of the attachment base 111, although the position of the sensor 139 is not limited thereto. The sensor 139 is configured to scan the vehicle component 50 and data from the scan is sent to the controller 80, either by wire or wirelessly. The data from the scan may be used to determine positions of the edge portions 50b of the vehicle component 50 that the clamp assembly 130 should clamp, and the controller 80 may control the linear actuator assemblies 120 based on the determined positions. The controller 80 may control the clamp assemblies 130 to rotate the lower jaws 131b to clamp the edge portions once the clamp assemblies 130 are at the determined positions.

The sensor 139 may scan the vehicle component 50 to determine a desired position of the vehicle component 50 for performing tasks on the vehicle component 50 and may determine ideal positions Iₓ of the clamp assemblies 130 that would position the vehicle component 50 at the desired position. The controller 80 may be or include a vision controller. The controller 80 may calculate the offsets Δₓ between the actual positions Aₓ of the clamp assemblies 130 and the ideal positions Iₓ of the clamp assemblies 130 and control the linear actuator assemblies 120 to move the clamp assemblies 130 by the offsets Δₓ such that the clamp assemblies 130 are in the ideal positions Iₓ thereof, and the vehicle component 50 is in the desired position. The actual positions Aₓ of the clamp assemblies 130 may be determined by, for example, extension distances of the rods 125 of the linear actuator assemblies 120, or real-time scans of the vehicle component 50 and/or the clamp assemblies 130. Once the vehicle component 50 is in its desired position, the tasks may be performed.

While the clamp assemblies 130 are configured to carry the weight of the vehicle component, the size of the vehicle component 50 along the first axis X may be relatively large relative to a thickness thereof along the third axis Z, which may result in a central portion of the vehicle component 50 sagging due to gravitational forces. To counteract the sagging, the carrier assembly 100 may further include grabber assemblies 140 to grab the surface 50a of the vehicle component 50 via vacuum forces.

Referring now to FIGS. 3-5 and 8, each of the grabber assemblies 140 includes a suction cup 141 disposed at a bottom end of a shaft 142 with a plate 144 therebetween. The suction cup 141, the shaft 142, and the plate 144 may include holes extending along the third axis Z and may be fluidly coupled to each other, and an upper end 147 of the shaft 142 may be fluidly coupled to a fluid suction mechanism 149. The fluid suction mechanism 149 may be, for example, a pump or a blower. The upper end 147 of the shaft 142 of each of the grabber assemblies 140 may be coupled to a separate fluid suction mechanism 149 or a single common fluid suction mechanism 149. The fluid suction mechanism 149 may be controlled by the controller 80 to turn the fluid suction mechanism 149 on and off, and/or to adjust the suction level at the fluid suction mechanism 149. When the suction cup 141 is flush against the surface 50a of the vehicle component 50, the suction forces from the fluid suction mechanism 149 may vacate air from within the suction cup 141 through the plate 144 and the shaft 142.

Each of the grabber assemblies 140 may include a grabber housing 145 that is mounted on the carrier frame 110 via the grabber bracket 119 extending from the first beam 113. The grabber housing 145 may include a locking structure disposed therein. The shaft 142 passes through the grabber housing 145 along the third axis Z and is movably mounted within the grabber housing 145 such that the shaft 142 is movable along the third axis Z as indicated by arrow M with respect to the grabber housing 145. The locking structure within the grabber housing 145 is configured to lock the shaft 142 in place when the suction cup 141 disposed on the shaft 142 is in a desired position. An elastic structure 143 is disposed around the shaft 142 between the plate 144 and the grabber bracket 119. The elastic structure 143 may be, for example, a coil spring. The upper end 147 of the shaft 142 may have a larger diameter than a remainder of the shaft 142 and may have a larger diameter than the hole formed in the grabber housing 145 such that the shaft 142 is prevented from falling out of the grabber housing 145.

Prior to the grabber assembly 140 coming in contact with the vehicle component 50, the locking structure is in an unlocked configuration such that the elastic structure 143 maintains the shaft 142 in a lowermost position along the third axis Z. When the robot arm assembly 90 moves the carrier assembly 100 atop the vehicle component 50 and is lowered to a position for clamping and grabbing the vehicle component 50, the suction cup 141 abuts the surface 50a of the vehicle component 50. As the carrier assembly 100 is lowered, the surface 50a of the vehicle component 50 pushes the suction cup 141 upward along the third axis Z such that the shaft 142 moves upward with respect to grabber housing 145, compressing the elastic structure 143 between the grabber bracket 119 and the plate 144. Once the carrier assembly 100 has reached its desired position with respect to the vehicle component 50, and the clamp assembly 130 has clamped the edge portions 50b of the vehicle component and moved the vehicle component 50 to the desired position for performing tasks thereon, the locking structure within the grabber housing 145 locks the shaft 142 such that the shaft 142 is immovable with respect to the grabber housing 145. The fluid suction mechanism 149 may be turned on to vacate air from within the suction cup 141 through the plate 144 and the shaft 142 such that the suction cup 141 grabs the surface 50a of the vehicle component 50 via the vacuum forces. Thus, the grabber assemblies 140 grab the surface 50a of the vehicle component 50 to prevent sagging of the vehicle component 50.

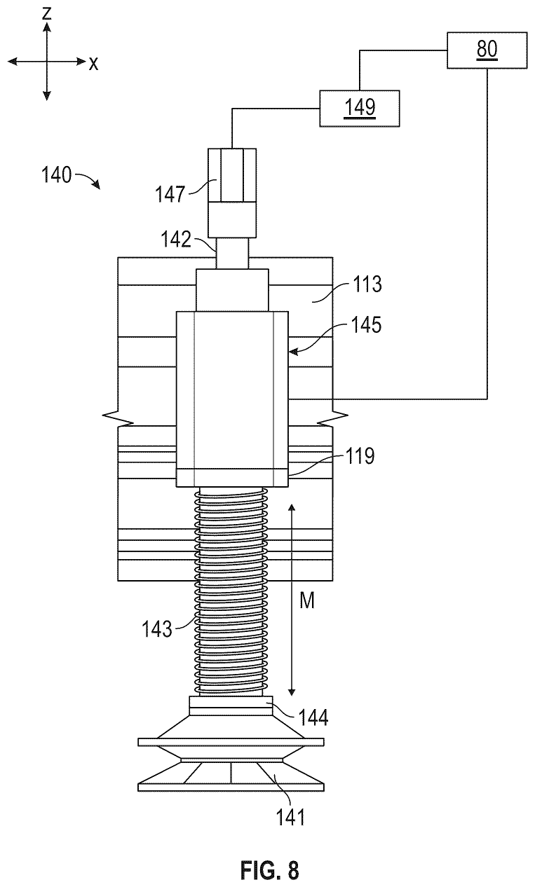

As shown in FIG. 8, the controller 80 may be connected to the locking structure in the grabber housing 145 to control the locking of the shaft 142, and/or the controller 80 may be connected to the fluid suction mechanism 149 to control the fluid suction mechanism 149.

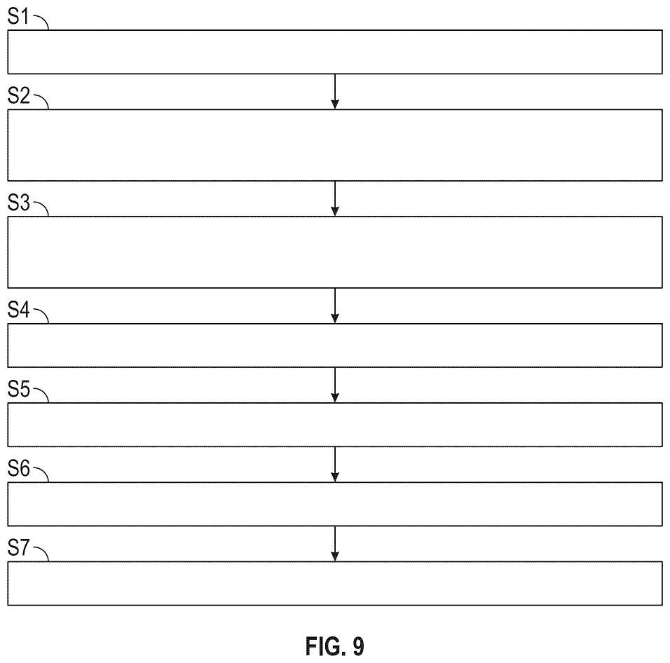

A method of carrying a vehicle component 50 according to one or more embodiments is shown in FIG. 9. In step S1, the robot arm assembly 90 is actuated to move a carrier assembly 100 into a desired position. The desired position may be, for example, above the vehicle component 50 such that the vehicle component 50 is positioned between clamp assemblies 130 of the carrier assembly 100. As the robot arm assembly 90 is moved to the desired position, the surface 50a of the vehicle component 50 may push the suction cup 141 and the shaft 142 of the grabber assembly 140 upward along the third axis Z with respect to the grabber housing 145, compressing the elastic structure 143. In step S2, the clamp assemblies 130 may be moved along the first axis X towards the vehicle component 50 until edge portions 50b of the vehicle component 50 are between the upper jaw 131a and the lower jaw 131b. The linear actuator assemblies 120 may be actuated to move the clamp assemblies 130 along the first axis X. In step S3, the lower jaw 131b of each clamp assembly 130 is rotated upward towards the edge portions 50b of the vehicle component 50 to clamp the edge portions 50b between the upper jaws 131a and the lower jaws 131b. In step S4, the clamp assemblies 130 may be moved along the first axis X to move the vehicle component 50 to a desired position for performing tasks thereon. In step S5, the shafts 142 of the grabber assemblies 140 are locked with respect to the grabber housing 145, which may be performed by the locking structure within the grabber housing 145. In step S6, the fluid suction mechanism 149 generates vacuum forces through the shafts 142 and the suction cups 141 of each of the grabber assemblies 140 such that the suction cups 141 grab the surface 50a of the vehicle component 50. In step S7, tasks are performed on the vehicle component 50 with the vehicle component 50 held in the desired position by the carrier assembly 100.

According to one or more embodiments, the controller 80 may perform at least steps S1-S5, alone or in combination with operator input. Depending on the tasks performed on the vehicle component 50, the controller 80 may also perform step S6, along in combination with operator input.

The carrier assembly 100 according to one or more embodiments is adjustable via the linear actuator assembly 120, the clamp assembly 130, and/or the grabber assembly 140 such capable of carrying a vehicle component 50 of various sizes and shapes. Thus, the carrier assembly 100 may eliminate the need for multiple carrier assemblies of differing shapes and sizes to accommodate differently shaped and sized vehicle components. Furthermore, the carrier assembly 100 may improve efficiency by eliminating the need to switch out carrier assemblies to handle differently shaped and/or sized vehicle components.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A carrier assembly for carrying a vehicle component defining a first axis, a second axis perpendicular to the first axis, and a third axis perpendicular to the first axis and the second axis, the carrier assembly comprising:
a carrier frame configured to be coupled to a robot arm assembly;
a linear actuator assembly mounted on the carrier frame and comprising a rod and a linear actuator that moves the rod linearly along the first axis; and
a clamp assembly fixed to the rod and configured to be moved linearly along the first axis, the clamp assembly comprising a first jaw and a second jaw configured to clamp an edge portion of the vehicle component.

2. The carrier assembly of claim 1, wherein the clamp assembly comprises a clamp arm on which the second jaw is disposed.

3. The carrier assembly of claim 2, wherein the clamp arm is configured to rotate about a hinge from an unclamped configuration to a clamped configuration.

4. The carrier assembly of claim 1, further comprising a controller configured to control the linear actuator and a sensor configured to send data indicating a position of the vehicle component to the controller.

5. The carrier assembly of claim 4, wherein the controller is configured to control the linear actuator to move the vehicle component to a desired position based on the data from the sensor.

6. The carrier assembly of claim 1, further comprising a grabber assembly configured to grab a surface of the vehicle component.

7. The carrier assembly of claim 6, wherein the grabber assembly comprises a suction cup fluidly coupled to a fluid suction mechanism that generates a vacuum force.

8. The carrier assembly of claim 7, wherein the fluid suction mechanism is a pump or a blower.

9. The carrier assembly of claim 7, wherein the grabber assembly further comprises a grabber housing mounted on the carrier frame and a shaft that passes through the grabber housing so as to be linearly movable with respect to the grabber housing along the third axis, the suction cup being disposed on the shaft.

10. The carrier assembly of claim 9, wherein the shaft has a hole extending therethrough along the third axis, the hole fluidly coupling the suction cup and the fluid suction mechanism.

11. The carrier assembly of claim 9, wherein the grabber housing comprises a locking structure configured to lock the shaft with respect to the grabber housing.

12. The carrier assembly of claim 9, wherein an elastic structure is disposed between the grabber housing and the suction cup, the elastic structure configured to bias the suction cup towards the surface of the vehicle component along the third axis.

13. The carrier assembly of claim 9, wherein the carrier frame comprises a beam extending along the first axis, and the grabber housing is directly mounted on a grabber bracket extending from the beam along the second axis.

14. The carrier assembly of claim 1, wherein the carrier frame comprises a beam extending along the first axis, and the linear actuator assembly is mounted on a support bracket extending from the beam along the second axis.

15. The carrier assembly of claim 3, wherein the clamp assembly comprises a vertical attachment structure, a horizontal attachment structure, and a main body attached to the vertical attachment structure and having the hinge mounted thereon, the first jaw being mounted on one of the vertical attachment structure and the horizontal attachment structure and the rod being attached to the other of the vertical attachment structure and the horizontal attachment structure.

16. A method of operating a carrier assembly defining a first axis, a second axis perpendicular to the first axis, and a third axis perpendicular to the first axis and the third axis, the method comprising:
moving the carrier assembly to a first position above a vehicle component along the third axis;
moving clamp assemblies of the carrier assembly along the first axis towards edge portions of the vehicle component until the edge portions are positioned between a first jaw and a second jaw of each of the clamp assemblies;
moving the second jaw to clamp the edge portions of the vehicle component between the first jaw and second jaw of each of the clamp assemblies; and
performing a task on the vehicle component.

17. The method of claim 16, wherein moving the carrier assembly to the first position comprises abutting suctions cups of grabber assemblies of the carrier assembly against a surface of the vehicle component and allowing the suction cups and shafts on which the suction cups are mounted to be pushed upward by the surface of the vehicle component along the third axis with respect to grabber housings of the grabber assemblies.

18. The method of claim 17, further comprising locking the shafts of the grabber assemblies so as to be immovable with respect to the grabber housings, and providing vacuum forces to the suction cups such that the suction cups grab the surface of the vehicle component.

19. The method of claim 16, further comprising:
determining a position of the vehicle component based on data from a sensor;
determining differences between actual positions of the clamp assemblies and ideal positions of the clamp assemblies determined based on the position of the vehicle component; and
moving the clamp assemblies holding the vehicle component along the third axis to the ideal positions.

20. A carrier assembly for carrying a vehicle component defining a first axis, a second axis perpendicular to the first axis, and a third axis perpendicular to the first axis and the second axis, the carrier assembly comprising:
a carrier frame configured to be coupled to a robot arm assembly, the carrier frame comprising a beam extending along the first axis, a first support bracket and a second support bracket extending from the beam along the third axis, and a first grabber bracket and a second grabber bracket extending from the beam along the second axis;
a first linear actuator assembly mounted on the carrier frame via the first support bracket, the first linear actuator assembly comprising first rod and a first linear actuator that moves the first rod linearly along the first axis;
a second linear actuator assembly mounted on the carrier frame via the second support bracket, the second linear actuator assembly comprising second rod and a second linear actuator that moves the second rod linearly along the first axis;
a first clamp assembly fixed to the first rod and configured to be moved linearly along the first axis, the first clamp assembly comprising a first upper jaw and a first lower jaw configured to clamp a first edge portion of the vehicle component, and a first clamp arm on which the first lower jaw is disposed;
a second clamp assembly fixed to the second rod and configured to be moved linearly along the first axis, the second clamp assembly comprising a second upper jaw and a second lower jaw configured to clamp a second edge portion of the vehicle component disposed opposite the first edge portion along the first axis;
a fluid suction mechanism that is a pump or a blower configured to generate a vacuum force;
a first grabber assembly configured to grab a surface of the vehicle component, the first grabber assembly comprising a first grabber housing mounted on the carrier frame via the first grabber bracket, a first shaft passing through the first grabber housing so as to be linearly movable with respect to the first grabber housing along the third axis, a first suction cup attached to the first shaft and fluidly coupled to the fluid suction mechanism via a first hole formed through the first shaft, a first locking structure within the first grabber housing configured to lock the first shaft with respect to the first grabber housing, and a first elastic structure disposed between the first grabber housing and the first suction cup and configured to bias the first suction cup towards the surface of the vehicle component along the third axis;
a second grabber assembly configured to grab a surface of the vehicle component, the second grabber assembly comprising a second grabber housing mounted on the carrier frame via the second grabber bracket, a second shaft passing through the second grabber housing so as to be linearly movable with respect to the second grabber housing along the third axis, a second suction cup attached to the second shaft and fluidly coupled to the fluid suction mechanism via a second hole formed through the second shaft, a second locking structure within the second grabber housing configured to lock the second shaft with respect to the second grabber housing, and a second elastic structure disposed between the second grabber housing and the second suction cup and configured to bias the second suction cup towards the surface of the vehicle component along the third axis; and
a controller configured to control the first linear actuator and the second linear actuator and a sensor configured to send data indicating a position of the vehicle component to the controller, the controller being configured to control the first linear actuator and the second linear actuator to move the vehicle component to a desired position based on the data from the sensor.
